(19) United States
(12) Patent Application Publication
(10) Pub. No.: US 2024/0163975 A1
(43) Pub. Date: May 16, 2024

(54) SYSTEM AND METHOD FOR HEATING A PORTABLE WATER PACK DISPENSING LINE

(71) Applicant: Steve Lepke, Wakefield, MA (US)

(72) Inventor: Steve Lepke, Wakefield, MA (US)

(21) Appl. No.: 18/389,575

(22) Filed: Nov. 14, 2023

Related U.S. Application Data
(60) Provisional application No. 63/425,036, filed on Nov. 14, 2022.

(51) Int. Cl. H05B 1/02; A45F 3/20; H05B 3/14

(52) U.S. Cl. CPC H05B 1/0297; A45F 3/20; H05B 3/145; A45F 2003/166

(57) ABSTRACT

The present general inventive concept provides a system for heating a portable liquid pack dispensing line. The system includes a power source, a heating element that is removably connected to the liquid dispensing line and extends in contacting relation with at least a portion of the liquid dispensing line, and a controller that is in operative connection with the power source and the heating element. The controller is configured to receive electrical current from the battery and to deliver electrical current to the heating element. Flow of electrical current through the heating element is operative to cause the heating element to produce heat and to transfer heat to the liquid dispensing line in contacting relation therewith.

### BACKGROUND OF THE INVENTION

### 1. Field of the Invention

The present general inventive concept relates to portable water packs and more particularly to a system and method for heating a portable water pack dispensing line.

### 2. Description of Related Art

There have been previous devices that have been developed for regulating the temperature of portable water or hydration packs. However, these previous devices are insufficient to safely and effectively regulate the temperature of liquids in portable water packs. Increasingly, people are venturing outdoors and engaging in hikes in national parks and exotic locations, as well as trips to amusement parks, zoos, festivals, and other attractions at which they will walk, exercise, or be exposed to the outdoor elements for long periods of time, for example wintery and snowy conditions. Various solutions for a portable supply of water have been proposed and used, including backpacks that have an interior water Tillable bladder with a tube or dispensing line connected thereto, a distal end of the dispensing line includes a valve operable to release the water from the dispensing line when the person wants to drink or otherwise use the water from the bladder.

During certain activities, such as snowboarding, skiing, snowmobiling, mountain climbing, snowshoeing, and other exercises or sports performed in cold weather atmospheres, outside temperatures can cause liquids in the dispensing line to freeze, which prevents the user from accessing the liquid in the bladder. Present practices for resolving this issue includes heating the line using friction, external heat sources such as submerging the dispensing line in higher temperature liquid, or simply waiting until higher ambient temperatures are encountered long enough to melt the water in the dispensing line. However, these solutions lack convenience and at times may become dangerous.

Therefore, what is desired is liquid dispensing line heating assembly to provide a convenient, safe, and effective system and method for heating liquid in a portable water or hydration pack dispensing line.

### BRIEF SUMMARY OF THE INVENTION

The present general inventive concept provides a system and method for heating a portable liquid pack dispensing line. The system includes a power source, a heating that is removably connected to the liquid dispensing line and that extends in contacting relation with at least a portion of the liquid dispensing line, and a controller that is in operative connection with the power source and the heating element. The controller is configured to receive electrical current from the battery and to deliver electrical current to the heating element. The flow of electrical current through the heating element is operative to cause the heating element to produce heat that is transferred to the liquid dispensing line in contacting relation therewith.

In alternative embodiments, the heating element may be a carbon wire.

In alternative embodiments, the controller may be a printed circuit board.

In alternative embodiments, the power source may be a battery.

In alternative embodiments, the system further includes a temperature sensor that is in operative connection with an interior area of the liquid dispensing line and that is operative to sense a temperature of the liquid within the liquid dispensing line.

In alternative embodiments, the controller includes a switch that is configured to be moved between an on position and an off position. In the on position, the controller is operative to deliver electrical current to the heating element, and in the off position, the controller does not deliver electrical current to the heating element.

In alternative embodiments, the controller is in operative connection with a processor and a non-transitory processor readable medium including processor executable instructions. The controller is configured to receive at least one signal from the temperature sensor indicating the temperature of the liquid in the liquid dispensing line. When the controller receives a signal indicating that the temperature of the liquid is above a pre-determined liquid temperature threshold, responsive to the processor executable instructions, the controller is operative to move the switch to the off position.

In alternative embodiments, the system further includes a sleeve designed as an elongated tube of flexible material that includes an interior area, a proximal opening, and a distal opening. The sleeve is configured to receive the liquid dispensing line and the heating element in the sleeve interior area through the proximal opening and enable the liquid dispensing line to extend out of the distal opening. The sleeve is further configured to maintain the heating element in contacting relation with the liquid dispensing line.

In alternative embodiments, the sleeve includes a reflective interior area lining configured to prevent heat loss by reflecting heat toward the sleeve interior area.

In alternative embodiments, the switch is a variable resistor switch, such that when the switch is in the on position, the controller is operable to cause the variable resistor switch to vary the electrical current delivered to the heating element.

In alternative embodiments, the temperature sensor is in operative connection with the heating element and is operative to sense the temperature of the heating element. The controller is configured to receive at least one signal from the temperature sensor indicating the temperature of the heating element. When the controller receives a signal indicating that the temperature of the heating element is above a pre-determined heating element temperature threshold, responsive to the processor executable instructions, the controller is operative to move the switch to the off position.

In alternative embodiments, the controller is configured to be wirelessly operated by at least one remote electronic device to control the electrical current delivered to the heating element.

In alternative embodiments, the present general inventive concept provides a system and method for heating liquid in a liquid dispensing line including a power source, a heating element that is removably connected to at least a portion of the liquid dispensing line, and a controller that is in operative connection with the power source and the heating element. The controller is configured to transfer electrical current from the battery to the heating element. The flow of electrical current through the heating element is operative to cause heat to be transferred to the liquid dispensing line.

In alternative embodiments, the heating element may be a carbon wire.

In alternative embodiments, the controller may be a printed circuit board.

In alternative embodiments, the power source may be a battery.

In alternative embodiments, the system further includes a temperature sensor that is in operative connection with the heating element and is operative to sense the temperature of the heating element.

In alternative embodiments, the controller includes a switch that is configured to be moved between an on position and an off position. In the on position, the controller is operative to transfer electrical current to the heating element, and in the off position, the controller does not transfer electrical current to the heating element.

In alternative embodiments, the controller is in operative connection with a processor and a non-transitory processor readable medium including processor executable instructions. The controller is configured to receive at least one signal from the temperature sensor indicating the temperature of the heating element. When the controller receives a signal indicating that the temperature of the heating element is above a pre-determined heating element temperature threshold, responsive to the processor executable instructions, the controller is operative to move the switch to the off position.

In alternative embodiments, the system further includes a sleeve that includes a sleeve interior area. The liquid dispensing line and the heating element extend through the interior area of the sleeve and are maintained in contacting relation. The interior area of the sleeve is lined with a reflective material that reflects the heat toward the sleeve interior area.

In alternative embodiments, the present general inventive concept provides a method of heating a portable liquid pack dispensing line. The method includes obtaining a liquid dispensing line heating device that includes a power source, a heating element, and a controller that is in operative connection with the power source and the heating element and that is operative to deliver electrical current from the battery to the heating element such that the flow of electrical current through the heating element is operative cause a temperature of the heating element to increase. The method further includes removably connecting the heating element in contacting relation with at least a portion of the liquid dispensing line. The method further includes variably delivering, using the controller, electrical current to flow through the heating element, whereby the liquid dispensing line is heated.

Additional features and embodiments of the present general inventive concept will be apparent from the following detailed description, drawings, and claims.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 illustrates a portable hydration pack modified with a liquid dispensing line heating assembly according to an exemplary embodiment of the present general inventive concept;

FIG. 2 illustrates a person hiking with a portable hydration pack supported on the person's back, the hydration pack is modified with the liquid dispensing line heating assembly illustrated in FIG. 1;

FIG. 3 illustrates assembled components of a liquid dispensing line heating assembly according to an exemplary embodiment of the present general inventive concept;

FIG. 4 illustrates the separate components of the liquid dispensing line heating assembly illustrated in FIG. 3;

FIG. 5 is a front view of a liquid dispensing line heating assembly according to an alternative exemplary embodiment of the present general inventive concept;

FIG. 6 is a side view of the liquid dispensing line heating assembly illustrated in FIG. 5;

FIG. 7 is a perspective view of components of a liquid dispensing line heating assembly according to an alternative exemplary embodiment of the present general inventive concept;

FIG. 8 is a perspective view of the liquid dispensing line heating assembly illustrated in FIG. 7;

FIG. 9 is a perspective view of the liquid dispensing line heating assembly illustrated in FIG. 7;

FIG. 10 is a schematic flow diagram of a method of using a liquid dispensing line heating assembly according to an alternative exemplary embodiment of the present general inventive concept; and

FIG. 11 is a perspective view of a liquid dispensing line heating assembly according to another embodiment of the present invention.

### DETAILED DESCRIPTION OF THE INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

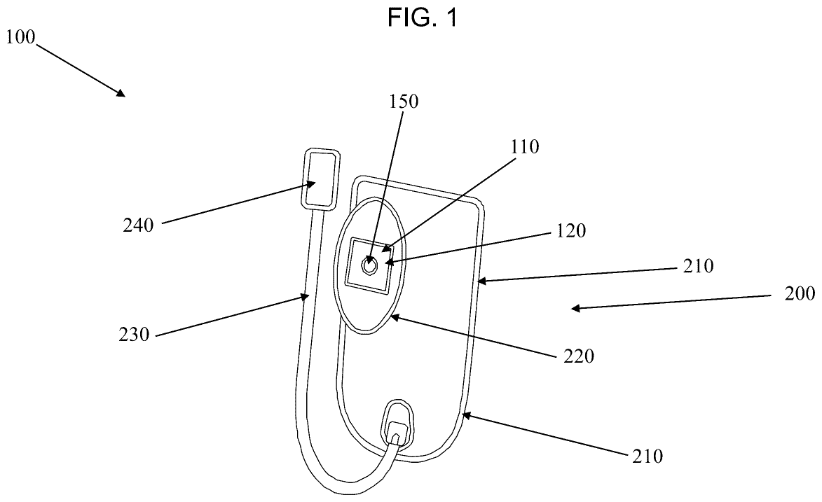

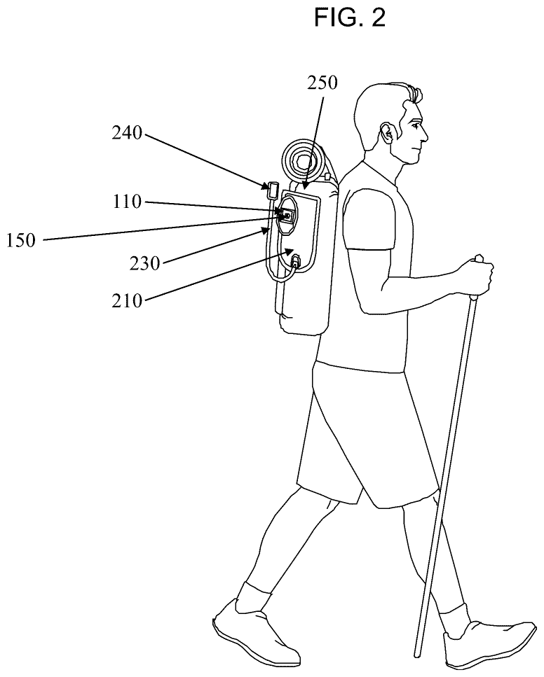

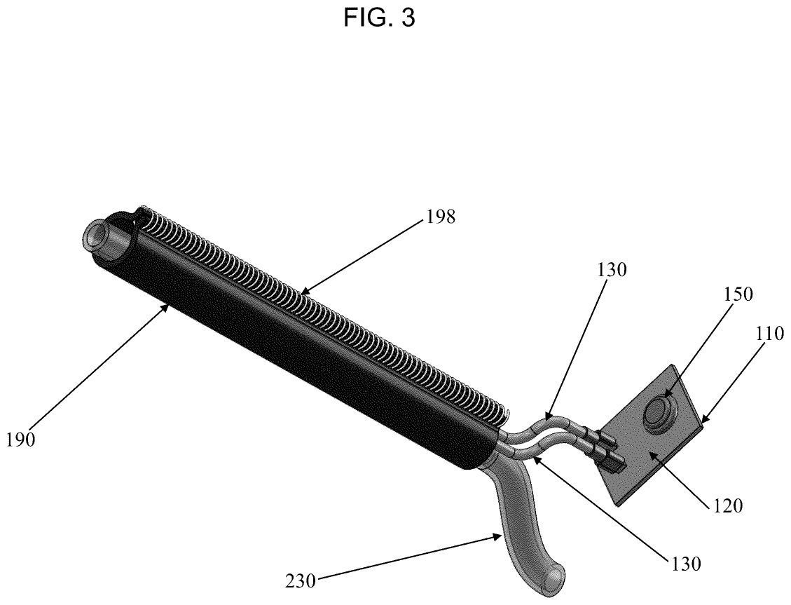

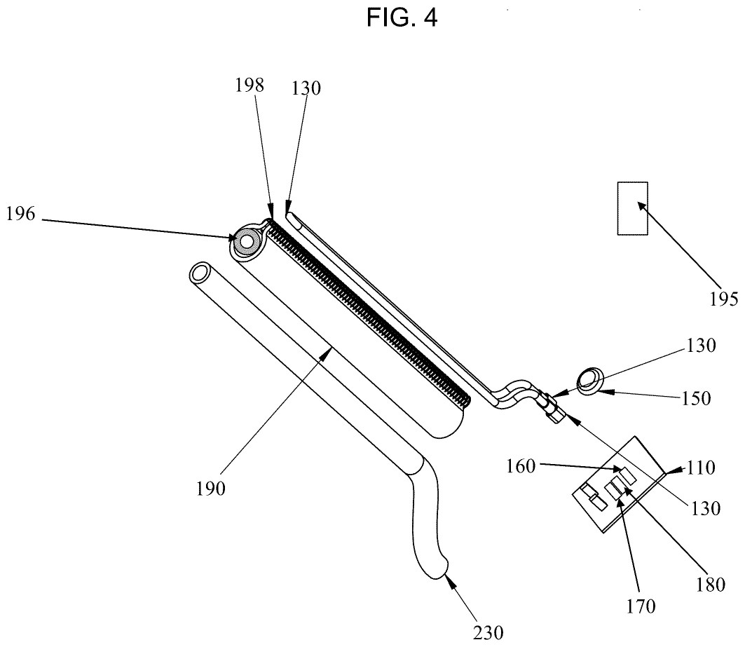

FIG. 1 illustrates a portable hydration pack modified with a liquid dispensing line heating assembly according to an exemplary embodiment of the present general inventive concept. FIG. 2 illustrates a person hiking with a portable hydration pack housed in a backpack supported on the person's back, the hydration pack is modified with the liquid dispensing line heating assembly illustrated in FIG. 1. FIG. 3 illustrates assembled components of a liquid dispensing line heating assembly according to an exemplary embodiment of the present general inventive concept. FIG. 4 illustrates the separate components of the liquid dispensing line heating assembly illustrated in FIG. 3.

Referring to FIGS. 1 through 4, the liquid dispensing line heating assembly, designated generally as 100, is illustrated. In the present embodiment, the liquid dispensing line heating assembly 100 is designed and configured as a convenient, safe, and effective means of heating liquid within a liquid dispensing line of a portable hydration pack, for example, by preventing freezing of the liquid within the liquid dispensing line. That is, the liquid dispensing line heating assembly 100 is designed to maintain liquid within a liquid dispensing line in a liquid state such that a user desiring to obtain the liquid from a liquid bladder of the portable hydration pack may do so without being impeded by frozen liquid due to low ambient temperature surrounding the user. However, the present general inventive concept is not limited thereto.

The present general inventive concept provides a liquid dispensing line heating assembly or system 100 for heating a portable liquid or hydration pack dispensing line. System 100 is configured to be removably attacheable to a portable liquid or hydration pack 200 and to maintain a liquid delivered to a user at a temperature where the liquid does not become slushy or frozen.

The exemplary portable hydration pack 200 includes any type of water, liquid, or hydration pack or back pack, or any other container designed to house a liquid and dispense a liquid. The exemplary portable hydration pack 200 includes a container or bladder 210 configured to hold a liquid such as, but not limited to, water. The pack 200 further includes a removable cap 220 in connection with the blader 210 that enables liquid to be delivered into the interior area of bladder 210. The cap 220 is manually operable to seal and unseal an opening through which water can be passed to fill the bladder 210 as needed. The pack 200 further includes a liquid dispensing line 230 such as, but not limited to, a clear plastic tub. The liquid dispensing line 230 may be a flexible conduit, tube, or other means of delivering water from the bladder 210 to the user. The liquid dispensing line 230 is in operative connection with the interior area of the bladder 210 and is configured to deliver liquid from the bladder 210 to a mouthpiece or valve 240. The valve 240 is configured to be opened and closed by a user of the pack 200 to obtain liquid from the liquid dispensing line 230. The valve 240 is configured to selectively allow or encourage liquid to leave the line 230. In alternative configurations, the closeable opening or valve 240 in a first configuration seals the end of line 230 and in another configuration opens the end of the of line 230, and a user of the valve 230 is enabled to manually switch between the first and second configurations. The exemplary portable hydration pack 200 is designed to be housed in a back pack 260 as shown in FIG. 2. However, the present general inventive concept is not limited hereto.

While the present general inventive concept is illustrated for use in connection with a bladder of a hydration pack, it should be understood that the exemplary embodiments can be used with any liquid source. Further, while the present invention is illustrated for use in connection with water, it should be understood that the exemplary embodiments can be used with any liquid, for example, to heat such liquid. However, the present general inventive concept is not limited thereto.

In one embodiment, system 100 includes a controller 110, a power source 120, and a heating element 130. The heating element 130 is configured to be removably connected to the liquid dispensing line 230 of the portable hydration pack 200 and to extend in contacting relation with at least a portion of the liquid dispensing line 230. The controller 110 is in operative connection with the power source 120 and the heating element 130. Controller 110 is configured to receive electrical current from the power source 120 and to deliver electrical current to the heating element 130. The flow of electrical current through the heating element 130 is operative to cause the heating element 130 to produce heat. The heat produced by the heating element 130 is transferred to the liquid dispensing line 230 as a result of the contacting relation between the heating element 130 and the liquid dispensing line 230. As a result, the liquid dispensing line 230 is maintained at a temperature which the liquid within the liquid dispensing line 230 is prevented from reaching a frozen, almost frozen, or solid state. However, the present general inventive concept is not limited thereto.

In exemplary embodiments, system 100 includes a controller 110. The controller 110 may be a printed circuit board. For example, the controller 110 is a printed circuit board or other circuit for heating the heating element 130. However, controller 110 may be another system or device configured to cause the functions, operations, and method steps discussed herein. The exemplary controller 110 is in operative connection with the power source 120 and the heating element 130. Controller 110 is configured to receive electrical current from the battery 130 and to deliver electrical current to the heating element 130.

In exemplary embodiments, system 100 includes a power source 120. The power source 120 is configured to provide power to the controller 110 to heat the heating element 130. The power source 120 may be, but is not limited to, a battery, for example, a lithium type battery. The exemplary battery is chargeable and may be designed for a low wattage draw such that the battery life of system 100 is prolonged. However, other battery types as well as other power sources may be used, including all known and later developed power source types.

The system 100 further includes a heating element 130. The exemplary heating element 130 may be, but is not limited to, a carbon wire heating element, an electrical conductor heating element, ceramic or semiconductor heating element, a resistance wire heating element, thick film heating element, polymer PTC heating element, a composite heating element, or any combination thereof. The heating element 130 is designed to receive electrical current from the battery 130 and the controller 170 and to generate or produce heat from the flow of electrical current through the heating element 130.

In exemplary embodiments, system 100 may include any means of activating the power source 120 and any means of activating the controller 110 to begin heating or stop heating the heating element 130. For example, such means include, but are not limited to, local control interfaces, remote control interfaces, computer or processor applications or software, mobile applications or software, as well as voice activated commands.

The exemplary heating element 130 is designed to be maintained in close proximity or contacting relation with the liquid dispensing line 230. In this manner, the heat produced by the heating element 130 can be directly or indirectly transferred to the liquid dispensing line 230. As the liquid dispensing line 230 receives the heat from the heating element 130, the temperature of any liquid within the liquid dispensing line 230 is caused to be increased, thereby preventing any transition of the liquid in the liquid dispensing line 230 from a liquid state to a solid or frozen state as a result of low ambient surrounding temperatures.

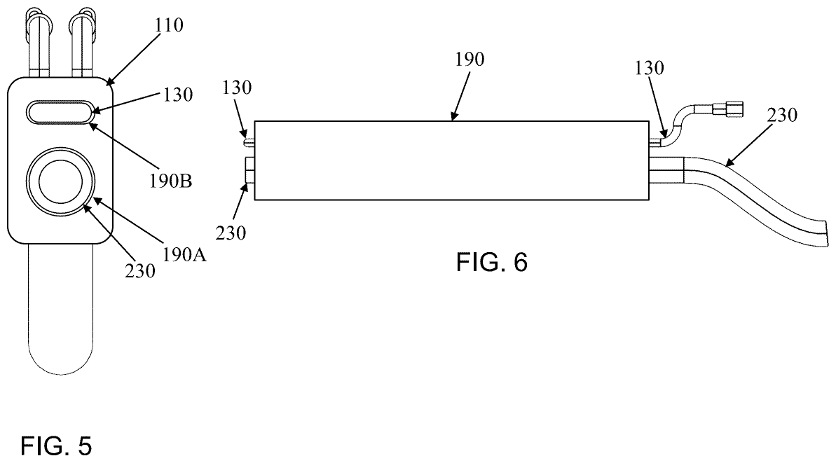

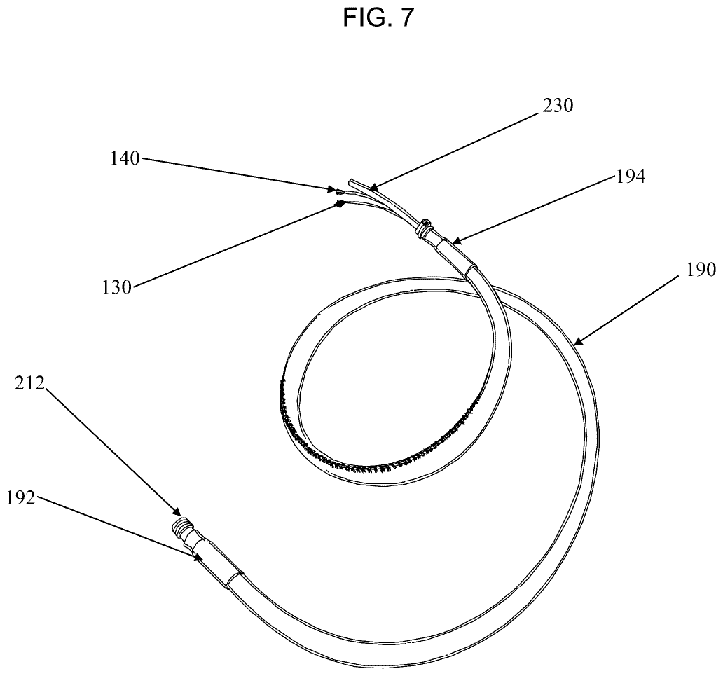

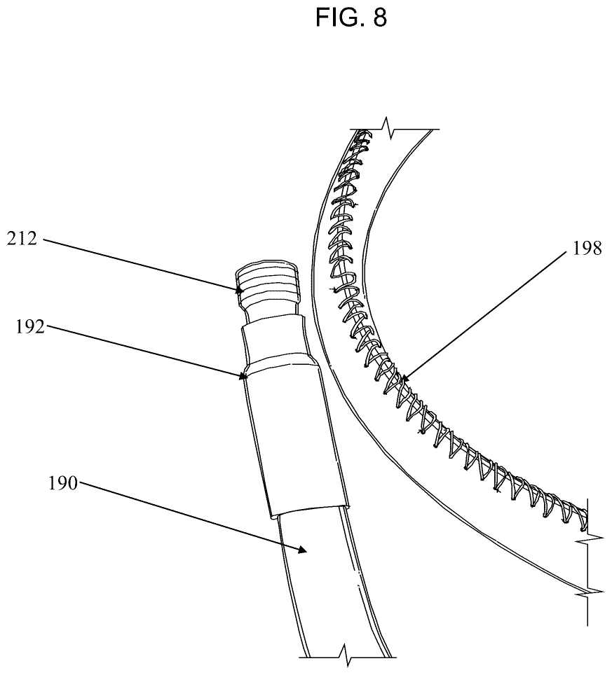

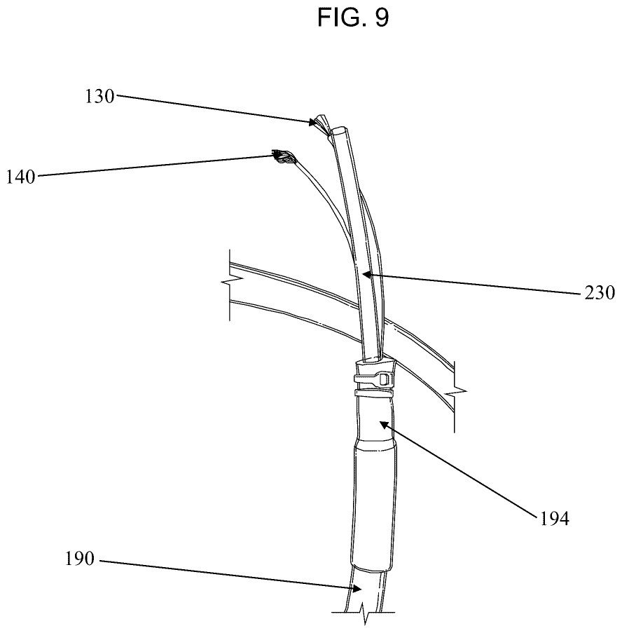

Referring now to FIGS. 5-9, in certain embodiments, the system 100 further includes a temperature sensor 140. The exemplary temperature sensor 140 may be any type of temperature sensor or gauge. For example, the temperature sensor 140 may be, but is not limited to, thermostats, thermistors, thermocouples, resistive temperature measuring devices, infrared sensors, bimetallic devices, thermometers, change of state sensors, a silicon diode, or any combination thereof. However, system 100 may includes any means for regulating the temperature setting of the heating element 130 and liquid in the liquid dispensing line 240. In exemplary embodiments, such temperature regulating means are configured and include the necessary components to collect, store, and transmit or receive data corresponding to the temperatures, temperature control or regulation, as welling as other temperature related information. However, the present general inventive concept is not limited thereto.

The exemplary temperature sensor is designed to sense the temperature of any liquid in the liquid dispensing line 230. The exemplary temperature sensor 140 is configured to communicate wirelessly or through a wired connection with the controller 110. For example, once temperature sensor 140 has determined a temperature, the sensor 190 is configured to transmit wirelessly or through a wired connection a signal or data corresponding to the determined temperature to the controller 110.

The exemplary temperature sensor 140 is configured to extend in an interior area of the liquid dispensing line 230. For example, temperature sensor 140 is configured to extend through valve 240, a mouthpiece, or other opening to the interior area of the liquid dispensing line 230. In certain embodiments, a user of system 100 is enabled to manually insert the temperature sensor 140 into the interior area of the liquid dispensing line 230 through the valve 240, mouthpiece, or other opening. In such embodiments, the temperature sensor 140 is configured to not impede flow nor promote leakage of the liquid in the liquid dispensing line 230. However, the present general inventive concept is not limited thereto.

In alternative embodiments, temperature sensor 140 is designed to be in operative connection with the heating element 130. In such embodiments, the temperature sensor 140 is designed to sense the temperature of the heating element and to communicate data corresponding to the temperature of the heating element to controller 110.

In still other alternative embodiments, the temperature sensor 140 is designed to also sense the ambient temperature surrounding the hydration pack 200 and to communicate data corresponding to the ambient temperature to controller 110.

In exemplary embodiments, controller 110 includes a switch 150. The exemplary switch 150 is configured to be moved by the controller 110 between an on position and an off position. In the on position, controller 110 is operative to deliver electrical current to the heating element 130. In the off position, controller 110 does not deliver electrical current to the heating element 130. In this way, controller 110 is operable to turn the system 100 on and off responsive to manual inputs to the controller 110.

In alternative embodiments, controller 110 is operable responsive to electrical signals or transmission received from remote electronic devices in operative connection and communication with the controller 110. That is, controller 110 is configured to receive signals from at least one remote electronic device to control system 100.

In alternative embodiments, the switch 150 may be a variable resistor switch 160. The variable resistor switch 160 is operated by controller 110 to vary the amount of electricity delivered to heating element 130, and thereby vary the amount of heat produced by the heating element 130. However, controller 110 may include other devices or mechanisms for controlling the amount of heat produced by the heating element 130. For example, at lower ambient temperatures, heating element 130 may be required to operate at a higher temperature in order to transfer enough heat to liquid dispensing line 230 in order to prevent the liquid in liquid dispensing line 230 from transitioning to a frozen or solid state. Similarly, in higher ambient temperatures, heating element 130 may require less heat and power from power source 120 to prevent the liquid from freezing. However, the present general inventive concept is not limited thereto.

In certain embodiments, the controller 110 includes or is in operative connection with at least one processor 170 and a non-transitory processor readable medium 180. Controller 110 is configured to communicate with the processor 170 and processor readable medium 180 wirelessly or through a wired connection. That is, in certain embodiments, controller 110 includes the processor 170 and the processor readable medium 180 as a single unit. In alternative embodiments, controller 110 is a specifically designed circuit to carry out the processor and memory functions to perform the operations and methods of system 100.

Processor readable medium 180 includes processor executable instructions that are designed to be executed by the processor 170 or controller 110 to perform the functions, operations, and method steps discussed herein. The exemplary processor executable instructions include commands for the controller 110 to turn the system on or off responsive to signals or other data received by the controller 110 from sensors associated with the system 100 or from remote electronic devices associated with the system 100. For example, the processor executable instructions may include temperature thresholds for liquid in the liquid dispensing line 230, the heating element 130, and the ambient temperature surrounding the hydration pack 200. The instructions may command controller 110 to turn the system 100 on or off as the threshold is approached or reached.

In such embodiments, the controller 110 is configured to receive at least one signal from the temperature sensor 140 indicating the temperature of the liquid within the liquid dispensing line 230, the temperature of the heating element 130, and/or the ambient temperature surrounding the hydration pack 200. Responsive to the received signal and the processor executable instructions, controller 110 is configured to turn the system 100 on or off. However, the present general inventive concept is not limited thereto.

In exemplary embodiments of the present general inventive concept, the system 100 further includes an insulation sleeve or covering 190. The exemplary sleeve 190 is designed as an elongated tube of flexible material having a proximal sleeve portion or opening 192 and a distal sleeve portion or opening 194. The exemplary flexible material is configured to enable a user move and manipulate the sleeve 190 without damage to any portion of system 100. Sleeve 190 is designed to receive the liquid dispensing line 230 and the heating element 130 through an interior area of the sleeve 190. The sleeve 190 is further designed to enable the liquid dispensing line 230 to extend out of the distal opening 194 to allow a user to obtain liquid via the valve 240 or mouthpiece.

In certain embodiments, exemplary sleeve 190 is securely held in place by a securing means such as stitching 198. However, the exemplary sleeve 190 may be held in place by other securing means such as elastic bands, ratchet and strap mechanisms, or any other securing means.

In certain embodiments, sleeve 190 includes separate residences or channels for each of the dispensing line 230 and the heating element 130. As shown in FIG. 5, sleeve 190 includes a first channel 190A for dispensing line 230 and a second channel 190B for heating element 130. Channels 190A and 190B are designed to extend adjacent one another to maintain the heating element 130 in close proximity to the dispensing line 230. In alternative configurations, channels 190A and 190B maintain the heating element 130 and line 230 in contacting relation, and in other configurations, the channels maintain line 230 and heating element 130 in close proximity separated by a thin membrane, for example, netting. However, the present general inventive concept is not limited thereto.

In exemplary embodiments, insulation sleeve 190 is formed of a material that maintains integrity when subjected to temperatures equal to or less than the temperatures to which the heating element 130 can be heated. Further, sleeve 190 is formed of a material or materials that absorb heat at its inwardly facing surface without transferring the heat through its outwardly facing surface, so as to insulate surrounding or nearby materials from the heat. That is, the sleeve 190 is designed to prevent heat damage to other materials near or in contacting relation with system 100 by insulating the heating element 130 from damaging those materials.

In certain embodiments, the exemplary sleeve 190 is designed to absorb or otherwise trap the heat produced by the heating element 130 generally in the interior area of the sleeve 190. In this manner, the life of the power source 120 is preserved and general ware and tare of the heating element 130 is slowed because the heat trapped by the sleeve 190 enables the heating element 130 and power source 120 to be used less.

In certain embodiments, the interior area of the exemplary sleeve 190 includes a reflective material 196. Reflective material 196 is designed to reflect radiation or heat back toward the interior area of the sleeve 190, thereby preventing heat loss and preserving the life of the heating element 130 and the power source 120. However, other materials and devices may be used to prevent heat loss and to preserve the life of system 100.

In some embodiments, system 100 is in operative connection with at least one remote electronic device 195. In such embodiments, the controller 110 is configured to communicate wirelessly with the remote electronic device 195. The remote electronic device 195 includes a processor, memory, display screen or output device, and an input device. For example, remote electronic device 195 may be, but is not limited to, a smart phone or other phone, a smart watch or other watch, a computer, a tablet, or any other electronic device capable of communicating data, signals, or other transmission with controller 110.

The remote electronic device 195 is designed to utilize software associated with the system 100 to control the system 100. That is, the remote electronic device 195 is configured to access software associated with the system 100 and to enable a user to issue commands to the controller 110 via manual or voice inputs to the device 195 and a user interface of the software. The device 195 is also configured to receive via the software signals, data, or other transmissions from the controller 110 and to display visual representations of the same on the display screen of the device 195 such that the user can monitor the system 100. For example, the device 195 may receive from the controller 110 and display visual representations of the temperature of the liquid in the liquid dispensing line 230, the temperature of the heating element 130, the ambient temperature surrounding the hydration pack 200, power source 120 life, heating element 130 life, volumes of the liquid within bladder 210, or any other status, error, or troubleshooting directions relating to system 100. However, the present general inventive concept is not limited thereto.

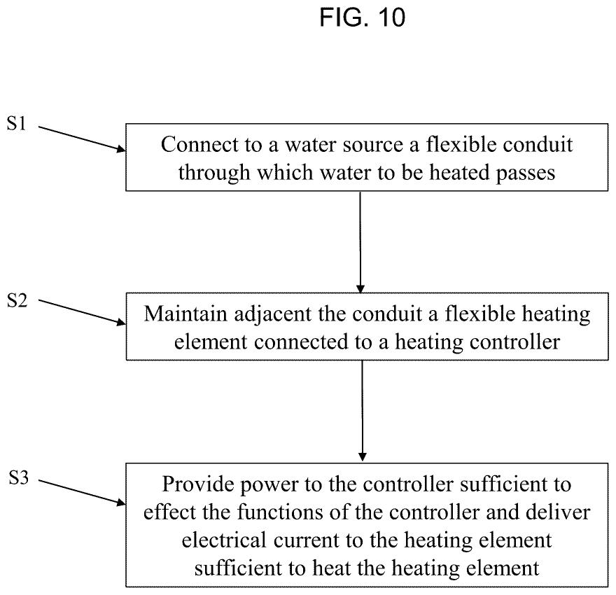

Referring now to FIG. 10, there is shown therein a method according the present general inventive concept. In step S1, a user connects to a water source a flexible conduit through which water to be heated passed. In step S2, the user maintains adjacent the conduit a flexible heating element connected to a heating controller. In step S3, a user provides power to the controller sufficient to effect the functions of the controller and deliver electrical current to the heating element sufficient to heat the heating element. However, the present general inventive concept is not limited thereto.

In an alternative method 1000 of heating a portable liquid or hydration pack dispensing line. The method 1000 utilizes system 100 as previously discussed. Method 1000 begins at step 1002 of obtaining a liquid dispensing line heating device such as system 100. Step 1004 requires a user to removably connect the heating element 130 in contacting relation with at least a portion of the liquid dispensing line 230. Step 1006 requires variably delivering, using the controller 110, electrical current to flow through the heating element 130, whereby the liquid dispensing line 230 is heated. As such, any liquid in liquid dispensing line 230 is maintained at a temperature that ensures the liquid does not transition to a solid or frozen state and the user is enabled to obtain the liquid from the liquid dispensing line 230. However, the present general inventive concept is not limited thereto.

In alternative embodiments, system 100 is configured to be powered via sunlight through a solar panel. Controller 110 is in operative connection with at least one solar panel. The exemplary solar panel is configured to convert sunlight into electricity via the photovoltaic effect. The exemplary power source 120 includes a solar battery storage unit configured to store the converted electricity. The exemplary controller 110 further includes necessary inverters and converters and any other components necessary to convert sunlight into electricity. The exemplary solar panel includes an attachment means configured to attach the solar panel to the user's back pack 250 or to another article of clothing or gear supported by the user.

In alternative embodiments, the exemplary system 100 includes a global positioning device, an avalanche beacon, transceiver, or other means for tracking and transmitting location information or data and enabling the user to be found in time of emergency.

In alternative embodiments, system 100 includes an inflatable avalanche protection unit or airbag. The exemplary inflatable avalanche protection unit is in operative connection with the controller 110 and is configured to inflate to create a safe, breathable, area under snow from an avalanche. The exemplary avalanche protection unit is configured to be inflated responsive to a manual input to system 100 by the user, or via sensors that are configured to determine when avalanche conditions are encountered.

In alternative embodiments, system 100 further includes a liquid volume sensor. The exemplary liquid volume sensor is in operative connection with the controller 110 and is configured to extend in the interior area of bladder 210. The exemplary liquid volume sensor is configured send at least one signal to the controller 110 indicating the current volume of liquid in the bladder 210. As such, the user is enabled to monitor the volume of liquid in the hydration pack 200 via the controller 110 and the user's remote electronic device.

In alternative embodiments, system 100 may be used in connection with and incorporated in articles of clothing such as, but not limited to, gloves, footwear, headwear, or any other wearable object to facilitate heating of the same in addition to or alternative to heating of the liquid. For example, an extended and more narrow liquid dispensing line may be connected to the bladder or to the already existing liquid dispensing line. The extended liquid line may be run through a jacket, a helmet, winter pants, ski or snowboard boots, or any other wearable. As the liquid is heated by the heating element, flow of the heated liquid through the liquid line is operable to heat the articles of clothing or the user's body. However, the present general inventive concept is not limited thereto.

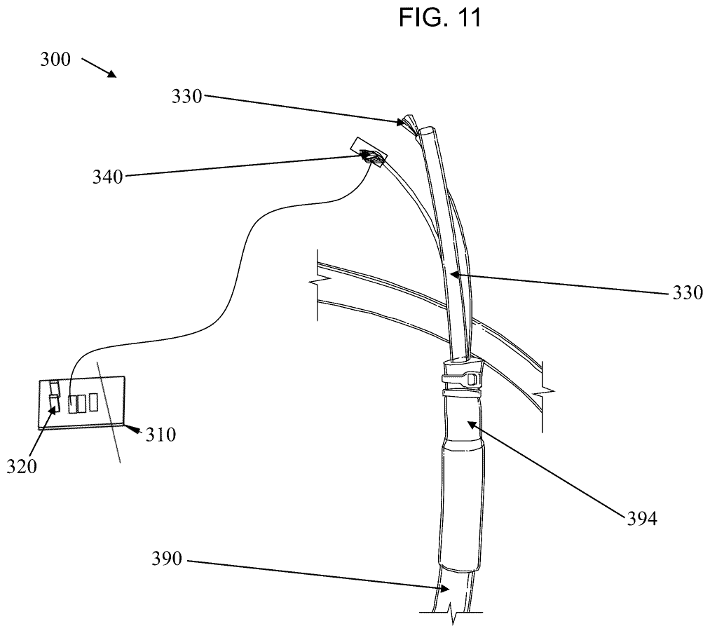

FIG. 11 is a perspective view of a liquid dispensing line heating assembly 300 according to another embodiment of the present invention.

In the present embodiment, the liquid dispensing line heating assembly 300 includes a controller 310, a power source 320, and a heating element 330 (substantially similar to previous embodiments). The heating element 330 is configured to be removably connected to the liquid dispensing line 330 of the portable hydration pack and to extend in contacting relation with at least a portion of the liquid dispensing line 330. The controller 310 is in operative connection with the power source 320 and the heating element 330.

Controller 310 is configured to receive electrical current from the power source 320 and to deliver electrical current to the heating element 330. The flow of electrical current through the heating element 330 is operative to cause the heating element 330 to produce heat. The heat produced by the heating element 330 is transferred to the liquid dispensing line 330 as a result of the contacting relation between the heating element 330 and the liquid dispensing line 230. As a result, the liquid dispensing line 330 is maintained at a temperature which the liquid within the liquid dispensing line 330 is prevented from reaching a frozen, almost frozen, or solid state. However, the present general inventive concept is not limited thereto.

In exemplary embodiments, system 300 includes a controller 310. The controller 310 may be a printed circuit board. For example, the controller 310 is a printed circuit board or other circuit for heating the heating element 330. However, controller 310 may be another system or device configured to cause the functions, operations, and method steps discussed herein. The exemplary controller 310 is in operative connection with the power source 320 and the heating element 330. Controller 310 is configured to receive electrical current from the battery 330 and to deliver electrical current to the heating element 330.

In the present embodiment, the system 300 includes a thermocouple 340 at the end of the liquid dispensing line 330 configured to monitor a temperature of the dispensed liquid. The thermocouple 340 is connected to the controller 310 via an electrical wire to provide feedback and control signals to adjust a temperature of the liquid. As such, the system 300 includes a feedback loop to ensure the dispensed liquid is identical to the set temperature. However, the present general inventive concept is not limited thereto.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A system for heating a portable liquid pack dispensing line, comprising:
a power source;
a heating element, wherein the heating element is removably connected to the liquid dispensing line and extends in contacting relation with at least a portion of the liquid dispensing line;
a controller, wherein the controller is in operative connection with the power source and the heating element;
wherein the controller is configured to receive electrical current from the battery and to deliver electrical current to the heating element; and
wherein flow of electrical current through the heating element is operative to cause the heating element to produce heat, and wherein the heating element is operative to transfer heat to the liquid dispensing line in contacting relation therewith.

2. The system of claim 1, wherein the heating element comprises a carbon wire.

3. The system of claim 2, wherein the controller comprises a printed circuit board.

4. The system of claim 3, wherein the power source comprises a battery.

5. The system of claim 4, further comprising a temperature sensor, wherein the temperature sensor is in operative connection with an interior area of the liquid dispensing line and is operative to sense the temperature of the liquid within the liquid dispensing line.

6. The system of claim 5, wherein the controller includes a switch, wherein the switch is configured to be moved between an on position and an off position,
wherein in the on position, the controller is operative to deliver electrical current to the heating element, and in the off position, the controller does not deliver electrical current to the heating element.

7. The system of claim 6, wherein the controller is in operative connection with a processor and a non-transitory processor readable medium including processor executable instructions,
wherein the controller is configured to receive at least one signal from the temperature sensor indicating the temperature of the liquid in the liquid dispensing line, and
wherein when the controller receives a signal indicating that the temperature of the liquid is above a pre-determined liquid temperature threshold, responsive to the processor executable instructions, the controller is operative to move the switch to the off position.

8. The system of claim 7, further comprising a sleeve, wherein the sleeve comprises an elongated tube of flexible material having an interior area, a proximal opening, and a distal opening,
wherein the sleeve is configured to receive the liquid dispensing line and the heating element in the sleeve interior area through the proximal opening and enable the liquid dispensing line to extend out of the distal opening, and
wherein the sleeve is configured to maintain the heating element in contacting relation with the liquid dispensing line.

9. The system of claim 8, wherein the sleeve includes a reflective interior area lining configured to prevent heat loss by reflecting heat toward the sleeve interior area.

10. The system of claim 9, wherein the switch comprises a variable resistor switch, wherein in the on position, the controller is operable to cause the variable resistor switch to vary the electrical current delivered to the heating element.

11. The system of claim 10, wherein the temperature sensor is in operative connection with the heating element and is operative to sense the temperature of the heating element,
wherein the controller is configured to receive at least one signal from the temperature sensor indicating the temperature of the heating element, and
wherein when the controller receives a signal indicating that the temperature of the heating element is above a pre-determined heating element temperature threshold, responsive to the processor executable instructions, the controller is operative to move the switch to the off position.

12. The system of claim 11, wherein the controller is configured to be wirelessly operated by at least one remote electronic device to control the electrical current delivered to the heating element.

13. A system for heating liquid in a liquid dispensing line, comprising:
a power source;
a heating element, wherein the heating element is removably connected to at least a portion of the liquid dispensing line;
a controller, wherein the controller is in operative connection with the power source and the heating element;
wherein the controller is configured to transfer electrical current from the battery to the heating element; and
wherein flow of electrical current through the heating element is operative to cause heat to be transferred to the liquid dispensing line.

14. The system of claim 13, wherein the heating element comprises a carbon wire.

15. The system of claim 14, wherein the controller comprises a printed circuit board.

16. The system of claim 15, wherein the power source comprises a battery.

17. The system of claim 16, further comprising a temperature sensor, wherein the temperature sensor is in operative connection with the heating element and is operative to sense the temperature of the heating element.

18. The system of claim 17, wherein the controller includes a switch, wherein the switch is configured to be moved between an on position and an off position, wherein in the on position, the controller is operative to transfer electrical current to the heating element, and in the off position, the controller does not transfer electrical current to the heating element.

19. The system of claim 18, wherein the controller is in operative connection with a processor and a non-transitory processor readable medium including processor executable instructions,
wherein the controller is configured to receive at least one signal from the temperature sensor indicating the temperature of the heating element, and
wherein when the controller receives a signal indicating that the temperature of the heating element is above a pre-determined heating element temperature threshold, responsive to the processor executable instructions, the controller is operative to move the switch to the off position.

20. The system of claim 19, further comprising a sleeve, wherein the sleeve includes an interior area,
wherein the liquid dispensing line and the heating element extend through the interior area of the sleeve and are maintained in contacting relation, and
wherein the interior area of the sleeve is lined with a reflective material that reflects the heat toward the sleeve interior area.

21. A method of heating a portable liquid pack dispensing line, comprising:
obtaining a liquid dispensing line heating device, wherein the heating device includes
a power source,
a heating element,
a controller, wherein the controller is in operative connection with the power source and the heating element, wherein the controller is operative to deliver electrical current from the battery to the heating element, and wherein flow of electrical current through the heating element is operative cause a temperature of the heating element to increase;
removably connecting the heating element in contacting relation with at least a portion of the liquid dispensing line; and
variably delivering, using the controller, electrical current to flow through the heating element, whereby the liquid dispensing line is heated.
